(19) United States
(12) Patent Application Publication
(10) Pub. No.: US 2014/0246363 A1
(43) Pub. Date: Sep. 4, 2014

(54) Brine Reclamation System for Water Softener

(71) Applicant: WATERITE TECHNOLOGIES, INC., Winnipeg (CA)

(72) Inventor: Paul V. Jacuzzi, Winnipeg (CA)

(21) Appl. No.: 13/782,599

(22) Filed: Mar. 1, 2013

(51) Int. Cl. C02F 1/42

(52) U.S. Cl. CPC C02F 1/42
USPC 210/126; 210/140

(57) ABSTRACT

A water softening system of the cation exchange type includes a regeneration system where there is a discharge duct for discharging waste flush water to waste from the treatment tank during regeneration with a valve for controlling the outlet and the discharge duct so that during regeneration the water from the treatment tank does not flow to the outlet and is instead directed to the discharge duct. A brine tank is provided for containing a solution of salt in water for injection by a transfer arrangement into the treatment tank with a return valve in the discharge duct operable to return a portion of the waste flush water to the brine tank which is equal to the quantity drawn by a brine transfer arrangement, while all waste flush water not returned to the brine tank is discharged to waste.

This invention relates to an apparatus for water softening which includes an arrangement for reclaiming brine used to regenerate the softening agent.

### BACKGROUND OF THE INVENTION

Water softening systems are known and widely used including particularly cation exchange systems of the type to which the present invention is directed. Thus where water supplied from a well or a utility main line is particularly hard, that is it has a high quantity of hard water ions, such as calcium or magnesium ions, it is often desirable to soften the water by removing the hard water ions and replace them with soft water ions, that is sodium ions through the use of a cation exchange water softener.

One type of traditional cation exchange water softener utilizes resin beads that are saturated with soft water ions. The hard water is passed over or around the resin beads, allowing the soft water ions to replace the hard water ions in the water. That is, the hard water ions will have become bound to the resin beads, while the soft water ions have been released from the resin beads and dispersed into the water. Eventually, the resin beads become saturated with hard water ions. As the number of soft water ions associated with the resin beads decreases, with the resin beads becoming saturated with hard water ions, the resin beads become less effective. A regeneration process is therefore periodically applied to the resin beads to remove the accumulated hard water ions from the resin beads and to resupply the resin beads with soft water ions.

During the regeneration process a saturated salt water (brine) solution is passed over the beads. The soft water ions in the brine solution displace the hard water ions on the resin beads and become associated with the resin beads. The freed hard water ions are then discharged with the remaining salt water/brine solution from a drain outlet of the water softener into a wastewater system.

The regeneration cycle, while necessary for the proper maintenance and operation of the example cation exchange water softener, generate significant maintenance expenses for an end user of the example cation exchange water softener. One such expense is the periodic replacement of a source of soft water ions. Typically, the end user will need to purchase sodium salt blocks, solar salt and/or pellets that are used to generate the salt water or brine solution used during the above-outlined regeneration cycle.

Another cost relates to the volume of water used by the example cation exchange water softener during the regeneration cycle. Whether the water used by the example cation exchange water softener comes from a well, a utility main line, or any other source, there are significant expenses associated with supplying and/or disposing of that water. In addition there are costs and environmental concerns associated with disposing of that water including local, environmental issues, such as droughts, water caps and water usage restrictions and the issues raised with dispending water with high salt content into the water treatment systems.

In three separate US Published applications 2011/0146822; 2011/0147282 and 2011/0147315 filed by Hellenbrand and all published Jun. 23 2011 there is disclosed a water discharge management system for a water processing system. The water processing system is connected to a first solution supply and to a second solution supply. A first multi-way valve is connected to a discharge outlet of the water processing system. A second multi-way valve is connected to the first multi-way valve and to a first water storage container. A third multi-way valve is connected to the second multi-way valve and to a second water storage container. The third multi-way valve is also connected to the first water supply. Also is disclosed a water discharge management system having a plurality of interconnected multi-way valves. At least one of the interconnected multi-way valves is coupled to a discharge port of a water processing system. The multi-way valves are controllable to selectively separate discharge water during a water processing cycle into waste, grey water, potable water, and regenerant solution such that discharge water is reclaimed by the system. The applications also disclose a method of water discharge management in a water processing system is also provided. The method includes providing a supply of a first solution, providing a supply of a second solution, and selectively supplying the first solution to a water processing system and the second solution to the water processing system. The method further includes controllably and selectively directing discharge water formed in the water processing system through a first multi-way valve to a waste outlet during a period in which the discharge water satisfies a first selected criterion, and to a second multi-way valve during a period in which the discharge water satisfies a second selected criterion. The method also includes controllably and selectively directing the discharge water through the second multi-way valve to a first storage container connected to the second multi-way valve during a period in which the discharge water satisfies a third selected criterion, and to a third multi-way valve during a period in which the discharge water satisfies a fourth selected criterion. In addition, the method includes controllably and selectively directing the discharge water through the third multi-way valve to a second storage container during a period in which the discharge water satisfies a fifth selected criterion, and the discharge water as a solution to the supply of first solution during a period in which the discharge water satisfies a sixth selected criterion.

The water discharge management system reclaims the discharged water to be used for one or more future purposes. In various examples of embodiments, the water discharge management system returns at least a portion of the discharged water to a brine tank or other regenerant solution storage tank used by the cation exchange water softener of the water discharge management system. In various other examples of embodiments, the water discharge management system directs one or more other portions of the discharged water to a storage tank for later use, such as, for example, use as grey water or as potable water.

The intention of the above system is therefore to reclaim all materials from the regeneration operation and to store the materials as grey water or in the brine. Thus the system is highly complicated and has not achieved significant acceptance.

The patent applications mentioned above are herein incorporated by reference.

Typically the water softening system for softening an incoming water supply to a water system comprises a treatment tank having an inlet connected to the water supply and an outlet connected to the water system for flow of water through the tank in a forward treatment direction where the treatment tank is arranged for containing cation exchange material by which hard water ions in the water supply are replaced as the water flows through the treatment tank by soft water ions carried by the exchange material.

Typically the regeneration of the treatment tank includes the following steps:

1. An optional reverse flush in which the incoming water is redirected in reverse flow direction though the treatment tank and the outgoing flow is directed to a discharge duct rather than to the outlet. This operates to remove any collected sediment or contamination filtered by the material.

2. Forward supply of flush water through the treatment tank where the water is fed to the discharge rather than to the outlet.

3. The addition of brine to the forward flush flow to regenerate the exchange material.

4. The halting of the brine flow and continuation of the flush flow to extract any remaining brine.

5. Operation of the valve to return the operation to the normal forward flow to outlet.

### SUMMARY OF THE INVENTION

It is one object of the invention to provide an improved water softening apparatus which provides a simple system allowing reclaiming of some of the brine.

According to one aspect of the invention the regeneration system for periodically regenerating the soft water ions on the cation exchange material comprises:
a discharge duct for discharging waste flush water to waste from the treatment tank during regeneration;
a valve for controlling the outlet and the discharge duct such that during regeneration the water from the treatment tank does not flow to the outlet and is instead directed to the discharge duct;
a brine tank for containing a solution of salt in water for injection into the treatment tank;
a transfer arrangement for transferring a quantity of the brine into the treatment tank during regeneration;
a controller for controlling operation of the valve and the transfer arrangement so as to control supply of the water and of the brine during regeneration;
and a return valve in the discharge duct operable to return a portion of the waste flush water to the brine tank;
the return valve being operable to return to the brine tank the portion which is arranged to equal the quantity drawn by the transfer arrangement while all waste flush water not returned to the brine tank is discharged to waste

Thus the system of the present invention provides a very simple system in which the system returns to the brine supply tank, which is not a separate storage tank, ONLY an amount that re-fills what has been taken out with the remaining waste brine being supplied to waste.

This is preferably done by using timing of the operation with a brine float valve in the brine tank acting as a failsafe sensor to shut off the return flow when the brine tank is refilled to a maximum level. In this case the return valve is preferably arranged to automatically switch back to the waste discharge in the event that the brine tank is refilled and the flow is halted.

In addition the controller is operated to select for return to the brine tank using a timing system the amount of brine which is timed to take from the brine waste the best value brine to be returned and over a time period timed to only re-fill the brine supply tank.

Thus the controller is preferably operable to control a period of time of operation of the valve for controlling a time period of water passing to the waste discharge and the controller is operable to control a period of time of operation of the transfer arrangement for injecting the brine.

Thus the controller is preferably operable to control a period of time of operation of the return valve during passage of the water toe the waste discharge to select from the discharge that portion of the discharge which contains the most brine and the least contaminants.

Preferably the return valve is a simple two way valve operable when actuated by the controller to switch flow to the brine tank.

Preferably the controller is a programmable controller operable to control timing of the valve and transfer arrangement and wherein the control of the return valve is selected as one timed operation of the controller.

Preferably the transfer arrangement comprises a venturi injector controlled by a valve operable by the controller.

### BRIEF DESCRIPTION OF THE DRAWINGS

One embodiment of the invention will now be described in conjunction with the accompanying drawings in which:

FIG. 1 is a schematic illustration of a water softening apparatus according to the present invention.

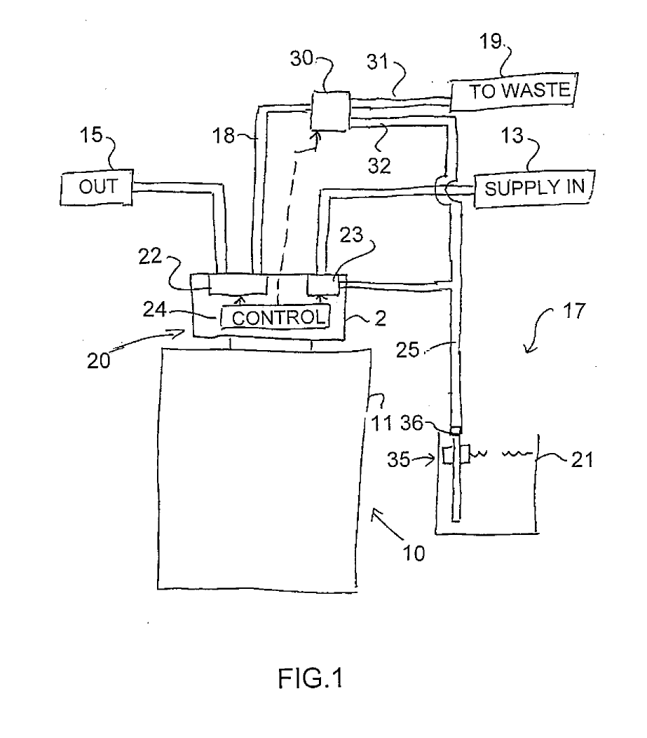

FIG. 2 is a timing diagram showing the time of operation of the valves and transfer arrangement by the controller of FIG. 1 and showing the level of brine and contaminants in the waste discharge.

FIG. 3 is a chart showing a series of set-up parameters for various sizes of softening system according to the present invention and the improvements in efficiency which are obtained thereby

### DETAILED DESCRIPTION

The apparatus 10 for softening a water supply for supply to an end use to a water system for example of a home or other premises provides a conventional system having a treatment tank 11 having an inlet 12 connected to the water supply 13 and an outlet 14 connected to the water system 15 for flow of water through the tank in a forward treatment direction D.

The treatment tank is arranged for containing conventional cation exchange material 16 by which hard water ions in the water supply are replaced as the water flows through the treatment tank by soft water ions carried by the exchange material.

A conventional regeneration system 17 for periodically regenerating the soft water ions on the cation exchange material includes a discharge duct 18 for discharging waste flush water to waste 19 from the treatment tank during regeneration. A multi-port control valve assembly 20 including a programmable controller 24 is provided for controlling the operation of the system. The valve assembly 20 includes a valve 22 which controls flow to the outlet 18 and the discharge duct 14 such that during regeneration the water from the treatment tank 11 does not flow to the outlet 15 and is instead directed to the discharge duct 18 and the waste 19.

A brine tank 21 is provided containing a solution 22 of salt in water for injection into the treatment tank. The multi-port control valve assembly 20 includes a venturi injector 23 for transferring a quantity of the brine into the treatment tank 11 during regeneration. The operation of the injector 23 is controlled by the system controller 24 so as to control supply of the water and of the brine during regeneration.

The control valve assembly 20 thus has a separate brine draw port 25 that is distinct from the raw water supply line. When the valve 20 moves to the brine draw position during regeneration, brine is sucked directly from the brine tank, through the brine float valve located in the brine tank, to the control valve and directed to the tank 11.

The brine port is opened by the control valve 20 at the point of the regeneration process that brine is introduced into the resin tank. The rate at which the brine is drawn into the tank is controlled by the size of the venturi or Injector' and sized based on the size of the mineral tank itself. Obviously, the larger the resin tank, the more brine that will be required to saturate the resin and the greater the brine flow that will be needed over the timed brine draw cycle.

The injector or transfer arrangement 23 and the valve 20 are typically timed by programming of the programmable controller 24 so that the quantity is controlled not by volume but by time, bearing in mind a generally constant flow rate. However volume sensors can be provided to more accurately control the volume of flow provided.

The regeneration system can also include a back-flush component in which the valve 20 controls the flow into the tank so that it flows in reverse direction to the forward flow direction D to lift the exchange material and remove any contaminants collecting at the bottom of the tank. However such back-flush which can be provided at the start-up of the regeneration cycle and/or at the end of the regeneration cycle is optional.

In the present arrangement a brine reclamation system is provided where a simple two way return valve 30 having two paths 31 and 32 is located in the discharge duct 18. The valve 30 is operable at a timed operation during the flow to the waste 19 to return a timed portion of the waste flush water to the brine tank 21 through the line 25.

The controller 24 operates the return valve 30 to return to the brine tank a portion of the water passing though the valve to waste 19. The portion fed back to the brine tank is arranged to exactly equal the quantity drawn by the transfer arrangement 23. This is done by operating the valve 30 over a time period arranged to exceed the required portion but to terminate before the end of the flush cycle.

The brine is diverted by valve 30 to line 25 via 32 by way of a “Y” connector and the brine flows back through a brine float valve 35 located in the tank at the end of line 25 into the brine tank 21. The float rises as the brine level goes up, and shuts off the flow by activating a valve 36 on line 25 at the level determined by the height of the float the float rod. This brine valve acts as the ‘fail-safe” to cut off the flow of brine from valve 30. The timed interval determined by the controller 24 is the principal determinant of the amount of brine that is diverted.

A mechanical float valve 35 in the brine tank can act to shut off the valve 36 in the line 25 in the event that the brine tank is refilled up to or beyond a maximum fill line which might be indicative of a failure in the control system. The valve is controlled by an adjustable float that can be set at various heights on a rod. The float's placement on the rod determines the amount of water that may be returned to the tank so that once the level of the brine reaches the float, it raises it and causes the return valve to close, impeding any further water from entering the brine tank.

This mechanical float valve actually acts as a ‘fail-safe’ device to assure that the tank is not over-filled. The amount of water returned to the brine during reclamation is principally controlled by the length of time that the reclamation diverter valve is programmed to be open, thus diverting reusable brine. However, should this diverter valve become inoperable or stuck in the diversion position, the float valve will assure that the brine tank is not over-filled.

Should the diverter valve and the float valve both fail, the brine tank is typically connected to a floor drain with an overflow tube to direct the overflow safely to waste.

The valve 30 is arranged when flow through the line 25 is halted to pass the flow back to the path 31 so that the further water all flows to waste. Thus the return valve is arranged to automatically switch back to the waste discharge in the event that the brine tank is refilled.

Thus the amount of the water containing salt solution which is returned to the brine tank exactly matches the amount drawn because the tank 21 is always refilled back to the fill line.

Thus all waste flush water not returned to the brine tank is simply discharged to waste.

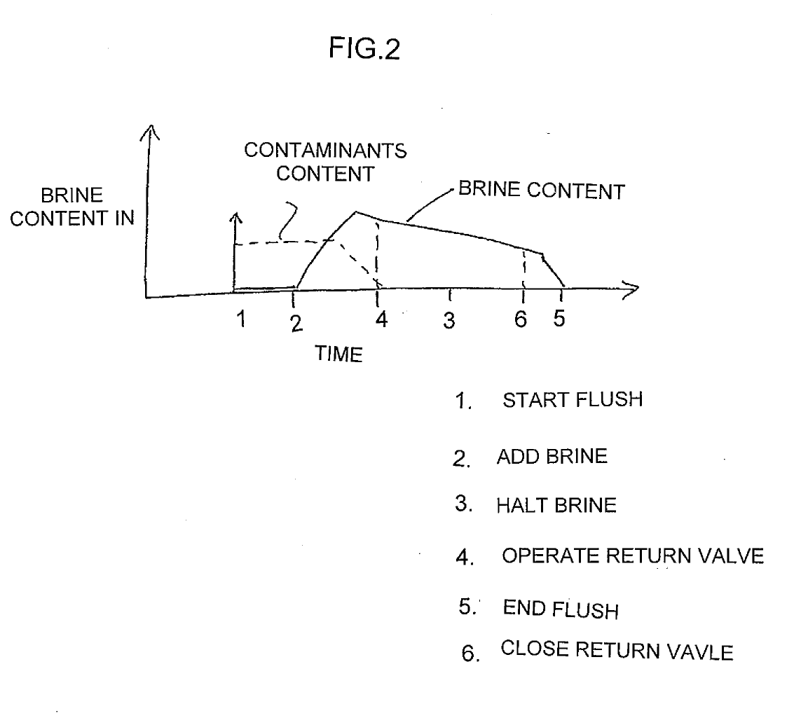

The controller is operable as shown in FIG. 2 to control a period of time of operation of the return valve at 4 and 6 during passage of the water to the waste discharge to select from the discharge that portion of the discharge which contains the most brine and the least contaminants.

The controller is a programmable controller of the type conventionally used with a system of this type and includes suitable outputs which are programmable to control timing of the valve and transfer arrangement and the control of the return valve is selected as one timed operation of the controller. Controllers of this type are conventionally available from Clack Corporation of Madison Wis.

Thus the system of the present invention requires in addition to the conventional system the addition of a simple valve 30 to the line 25. The fill sensor 35 is typically provided to control refilling of the tank 21 with clean water from the supply. In this case however the refilling action uses reclaimed brine so as to reduce the amount of salt lost and needing to be replaced and also to reduce the amount of salt discharged to the environment at the waste 19.

The system of the present invention can be provided in a number of softener sizes. These sizes are referred to by the number of grains of hardness capacity the resin bed theoretically has. The sizes are 20,000, 30,000, 40,000, 50,000, 60,000, 90,000, 120,000 and 150,000. Each of these sizes (hardness capacity) requires a progressively larger resin tank hence requiring more brine to regenerate the resin bed. The control valve used on each size of tank is fitted with the appropriately sized injector 23 to assure that the correct amount of brine is drawn during regeneration.

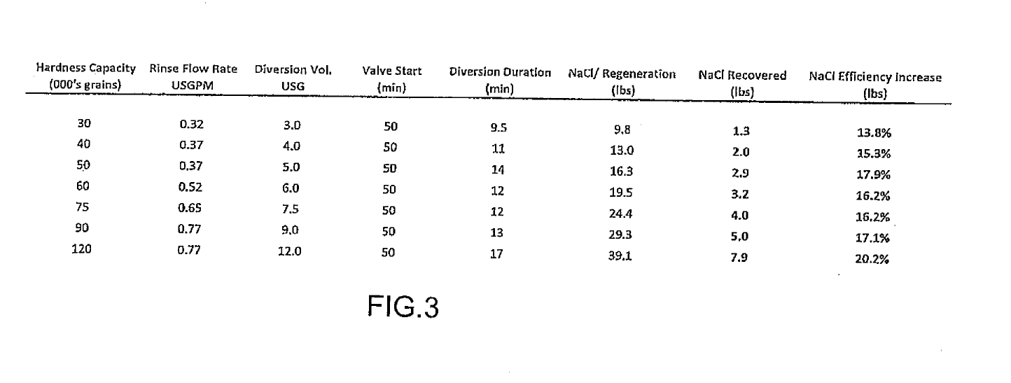

FIG. 3 provides a chart which provides a series of setup parameters that have observed been and calculated, for each size of unit capacity, where:

1. The Rinse Flow Rate is based on 50PSI (a good estimate of the average residential system pressure in North America) and the DLFC (drain line flow control) installed for each size unit.

2. The Diversion Duration is the actual time that the diversion valve is directing waste brine back to the brine holding tank.

3. The Diversion Volume is the amount of water in US gallons that will be diverted to the brine tank. This volume is equivalent to the volume of water that will be required on the next regeneration cycle. The system has conserved/recycled the volume of water diverted and the dissolved salt in the diverted brine.

4. NaCl/Regeneration is the amount of salt, in weight, contained in the water used for regeneration.

5. The NaCl Recovered is the amount of salt in pounds, which is recovered in the diverted waste brine solution.

6. The NaCl Efficiency Increase is the amount of salt, in weight, that is recovered by the present system, as a percentage of the NaCl/Regeneration.

One important assumption is that during the slow brine rinse there is minimal change in the dilution rate of the brine solute.

This body of data was calculated on the assumption that at regeneration the softener will be near or at capacity, less the usual reserve that the control valve automatically builds in. This enables a time to be fixed in the slow rinse cycle when diversion begins; at this point the rinse water contains a minimal amount of calcium ions and is mainly sodium brine. This is a fair assumption; the control valves that are used in the system to use their computer and turbine to calculate remaining hardness capacity based on water use. At the point where the system reaches 25% remaining, it schedules a regeneration at the next time set point (usually 2:00 AM, though it could be set at any time). Regardless of the raw water hardness or the amount of water used, the softener will be near or at capacity when it regenerates. The only exception would be when the operator intentionally overrides the computer and manually initiates an early regeneration. This would be a rare occasion and would not reduce the amount of brine recovered. It would merely increase the amount of recoverable brine that would be wasted to drain before the diversion valve was actuated.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Water softening apparatus comprising:
a treatment tank having an inlet connected to a water supply and an outlet for flow of water through the tank in a forward treatment direction;
the treatment tank being arranged for containing cation exchange material by which hard water ions in the water supply are replaced as the water flows through the treatment tank by soft water ions carried by the exchange material;
and a regeneration system for periodically regenerating the soft water ions on the cation exchange material comprising:
a discharge duct for discharging waste flush water to waste from the treatment tank during regeneration;
a valve for controlling the outlet and the discharge duct such that during regeneration the water from the treatment tank does not flow to the outlet and is instead directed to the discharge duct;
a brine tank for containing a solution of salt in water for injection into the treatment tank;
a transfer arrangement for transferring a quantity of the brine from the brine tank into the treatment tank during regeneration;
a controller for controlling operation of the valve and the transfer arrangement so as to control supply of the water and of the brine during regeneration;
and a return valve in the discharge duct operable to return a portion of the waste flush water to the brine tank;
the return valve being operable to return to the brine tank the portion which is arranged to equal the quantity drawn by the transfer arrangement while all waste flush water not returned to the brine tank is discharged to waste.

2. The apparatus according to claim 1 wherein the controller is operable to control a period of time of operation of the valve for controlling a time period of water passing to the waste discharge and the controller is operable to control a period of time of operation of the transfer arrangement so as to control by timing the volume of the portion returned to the brine tank.

3. The apparatus according to claim 1 wherein the controller is operable to control a period of time of operation of the return valve during passage of the water to the waste discharge to select from the discharge that portion of the discharge which contains the most brine and the least contaminants.

4. The apparatus according to claim 1 wherein there is provided a fill control sensor in the brine tank which shuts off the return valve when the brine tank is refilled to a maximum fill position.

5. The apparatus according to claim 1 wherein the return valve is a simple two way valve operable when actuated by the controller to switch flow to the brine tank.

6. The apparatus according to claim 1 wherein the controller is a programmable controller operable to control timing of the valve and the transfer arrangement and wherein the control of the return valve is selected as one timed operation of the controller.

7. The apparatus according to claim 1 wherein the transfer arrangement comprises a venturi injector controlled by a valve operable by the controller.
